(19) United States
(12) Patent Application Publication
(10) Pub. No.: US 2021/0058285 A1
(43) Pub. Date: Feb. 25, 2021

(54) BEAM FAILURE PROCESSING METHOD, TERMINAL, AND NETWORK DEVICE

(71) Applicant: VIVO MOBILE COMMUNICATION CO., LTD., Chang'an Dongguan (CN)

(72) Inventors: Yumin WU, Chang'an Dongguan (CN); Li CHEN, Chang'an Dongguan (CN)

(73) Assignee: VIVO MOBILE COMMUNICATION CO., LTD., Chang'an Dongguan (CN)

(21) Appl. No.: 17/035,213

(22) Filed: Sep. 28, 2020

Related U.S. Application Data
(63) Continuation of application No. PCT/CN2019/078116, filed on Mar. 14, 2019.

(30) Foreign Application Priority Data
Mar. 28, 2018 (CN) 201810266184.4

(51) Int. Cl. H04L 12/24; H04W 74/08; H04W 24/08; H04W 72/04

(52) U.S. Cl. CPC H04L 41/0668; H04W 74/0833; H04L 41/0803; H04W 72/04; H04W 24/08

(57) ABSTRACT

This disclosure discloses a beam failure processing method, a terminal, and a network device. The method includes: receiving, from a network device side, configuration information of a random access resource for transmitting a beam failure recovery request message, where the configuration information is used to indicate whether the network device has configured the random access resource for a secondary cell SCell; and when a beam failure occurs in the SCell, determining, based on an indication of the configuration information, whether to send a beam failure recovery request message to the network device.

### CROSS-REFERENCE TO RELATED APPLICATIONS

This application is a continuation application of PCT Application No. PCT/CN2019/078116 filed Mar. 14, 2019, which claims priority to Chinese Patent Application No. 201810266184.4, filed in China on Mar. 28, 2018, which is incorporated herein by reference in their entireties.

### TECHNICAL FIELD

This disclosure relates to the field of communications technologies, and in particular, to a beam failure processing method, a terminal, and a network device.

### BACKGROUND

A fifth generation (5 Generation, 5G) mobile communications system uses a dual connectivity (Dual Connectivity, DC) architecture including a master cell group (Master Cell Group, MCG) and a secondary cell group (Secondary Cell Group, SCG). The MCG corresponds to a master node (Master Node, MN) on a network device side, and the SCG corresponds to a secondary node (Secondary Node, SN) on the network device side. The MCG includes a primary cell (Primary Cell, PCell) and a secondary cell (Secondary Cell, SCell). The SCG includes a primary/secondary cell (Primary/Secondary Cell, PSCell) and a secondary cell SCell. The PCell and the PSCell may also be collectively referred to as an SpCell.

When a terminal encounters a downlink beam failure in the PCell, the terminal initiates a beam failure recovery request procedure (beam failure recovery request procedure). The terminal sends a random access preamble (preamble) in the PCell, and waits in the PCell for receiving feedback information from a network device, where the feedback information is a physical downlink control channel (Physical Downlink Control Channel, PDCCH) scheduled with a cell radio network temporary identifier (Cell Radio Network Temporary Identifier, C-RNTI). After the terminal receives the feedback information from the network device with respect to the beam failure recovery request, the terminal determines that a beam (or service) corresponding to the cell successfully recovers. However, when the terminal encounters a beam failure in the SCell, if both the SCell and the PCell are configured with contention-based random access resources, the terminal does not know how to notify the network device of a cell in which a beam failure occurs, and cannot determine which contention-based random access resource should be selected for beam recovery.

### SUMMARY

Embodiments of this disclosure provide a beam failure processing method, a terminal, and a network device, to resolve a problem that a terminal cannot determine how to perform processing when the terminal encounters a beam failure in an SCell in the prior art.

According to a first aspect, an embodiment of this disclosure provides a beam failure processing method, applied to a terminal side, including:

receiving, from a network device side, configuration information of a random access resource for transmitting a beam failure recovery request message, where the configuration information is used to indicate whether the network device has configured the random access resource for a secondary cell SCell; and

when a beam failure occurs in the SCell, determining, based on an indication of the configuration information, whether to send a beam failure recovery request message to the network device.

According to a second aspect, an embodiment of this disclosure further provides a terminal, including:

a first receiving module, configured to receive, from a network device side, configuration information of a random access resource for transmitting a beam failure recovery request message, where the configuration information is used to indicate whether the network device has configured the random access resource for a secondary cell SCell; and

a processing module, configured to: when a beam failure occurs in the SCell, determine, based on an indication of the configuration information, whether to send a beam failure recovery request message to the network device.

According to a third aspect, an embodiment of this disclosure provides a terminal, including a processor, a memory, and a computer program stored in the memory and capable of running on the processor, where when the computer program is executed by the processor, steps of the foregoing beam failure processing method are implemented.

According to a fourth aspect, an embodiment of this disclosure provides a beam failure processing method, applied to a network device side, including:

sending, to a terminal, configuration information of a random access resource for transmitting a beam failure recovery request message, where the configuration information is used to indicate whether the random access resource is configured for a secondary cell SCell of the terminal.

According to a fifth aspect, an embodiment of this disclosure provides a network device, including:

a first sending module, configured to send, to a terminal, configuration information of a random access resource for transmitting a beam failure recovery request message, where the configuration information is used to indicate whether the random access resource is configured for a secondary cell SCell of the terminal.

According to a sixth aspect, an embodiment of this disclosure further provides a network device, including a processor, a memory, and a computer program stored in the memory and capable of running on the processor, where when the processor executes the computer program, steps of the foregoing beam failure processing method are implemented.

According to a seventh aspect, an embodiment of this disclosure provides a computer-readable storage medium, where the computer-readable storage medium stores a computer program, and when the computer program is executed by a processor, steps of the foregoing beam failure processing method are implemented.

Therefore, in the embodiments of this disclosure, configuration information is used to indicate whether a random access resource for beam failure recovery has been configured for the SCell; and when a beam failure occurs in the SCell, a beam failure recovery procedure is initiated based on an indication of the configuration information, so that beam failure recovery on the terminal side and beam failure recovery on the network device side keep consistent to complete beam failure recovery of the SCell.

### BRIEF DESCRIPTION OF DRAWINGS

To describe the technical solutions in the embodiments of this disclosure more clearly, the following briefly describes the accompanying drawings required for describing the embodiments of this disclosure. Apparently, the accompanying drawings in the following description show merely some embodiments of this disclosure, and a person of ordinary skill in the art may still derive other drawings from these accompanying drawings without creative efforts.

FIG. 1 presents a schematic flowchart of a beam failure processing method on a terminal side according to an embodiment of this disclosure;

FIG. 2 presents a schematic flowchart of beam failure recovery in non-contention based random access according to an embodiment of this disclosure;

FIG. 3 presents a schematic flowchart of beam failure recovery in contention-based random access according to an embodiment of this disclosure;

FIG. 4 presents a schematic modular structural diagram of a terminal according to an embodiment of this disclosure;

FIG. 5 presents a block diagram of a terminal according to an embodiment of this disclosure;

FIG. 6 presents a schematic flowchart of a beam failure processing method on a network device side according to an embodiment of this disclosure;

FIG. 7 presents a schematic modular structural diagram of a network device according to an embodiment of this disclosure; and

FIG. 8 presents a block diagram of a network device according to an embodiment of this disclosure.

### DESCRIPTION OF EMBODIMENTS

The following describes exemplary embodiments of this disclosure in more detail with reference to the accompanying drawings. Although the exemplary embodiments of this disclosure are shown in the accompanying drawings, it should be understood that this disclosure may be implemented in various forms and should not be limited by the embodiments set forth herein. On the contrary, the embodiments are provided to enable a more thorough understanding of this disclosure and completely convey the scope of this disclosure to a person skilled in the art.

The terms “first”, “second”, and the like in this specification and claims of this application are used to distinguish between similar objects instead of describing a specific order or sequence. It should be understood that the data used in this way is interchangeable in appropriate circumstances so that the embodiments of this application described herein can be implemented in other orders than the order illustrated or described herein. In addition, the terms “include”, “have”, and any other variant thereof are intended to cover a non-exclusive inclusion. For example, a process, method, system, product, or device that includes a list of steps or units is not necessarily limited to those steps or units that are expressly listed, but may include other steps or units that are not expressly listed or are inherent to the process, method, system, product, or device.

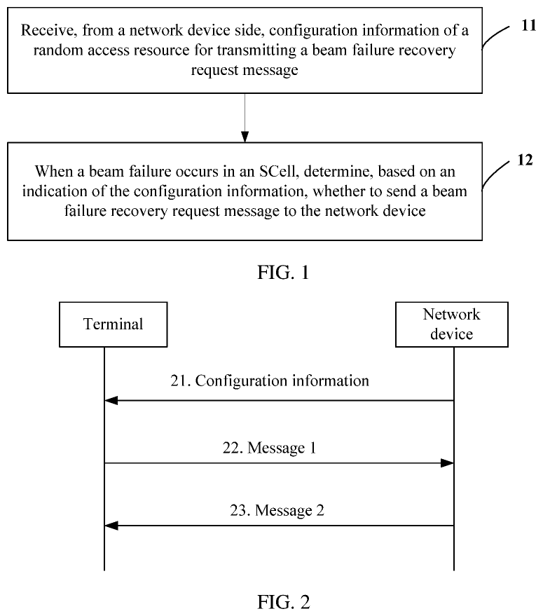

An embodiment of this disclosure provides a beam failure processing method, applied to a terminal side. As shown in FIG. 1, the method includes the following steps.

Step 11: Receive, from a network device side, configuration information of a random access resource for transmitting a beam failure recovery request message.

The configuration information is used to indicate whether the network device has configured the random access resource for a secondary cell SCell. For one or more SCells of a terminal, the network device configures a resource used for a beam failure recovery request message. Herein, the random access resource includes a physical random access channel (Physical Random Access Channel, PRACH) resource that is reserved by the network device for the terminal and used for transmitting a beam failure recovery request. It should be noted that in the PRACH resource configured by the network device, one part of the resource is used for common random access purposes other than beam failure recovery of the terminal, and the other part of the resource is used by the terminal to send a beam failure recovery request when a beam failure occurs, and the two parts of the resource are orthogonal. To be specific, the PRACH resource used for sending a beam failure recovery request and the PRACH resource used for common random access are orthogonal (for example, orthogonal in time domain, orthogonal in frequency domain, and/or orthogonal in code domain). Herein, the random access resource may be a non-contention based random access resource (such as a PRACH resource configured by dedicated PRACH-Config) or may be a contention-based random access resource (such as a PRACH resource configured by common PRACH-Config).

Step 12: When a beam failure occurs in the SCell, determine, based on an indication of the configuration information, whether to send a beam failure recovery request message to the network device.

When the beam failure occurs in the SCell, the terminal determines, based on the indication of the configuration information, whether to send a beam failure recovery request message to the network device, and if yes, starts a beam failure recovery procedure, or if no, triggers a beam failure processing procedure. Therefore, when the beam failure occurs in the SCell, the terminal can initiate the beam failure recovery procedure based on the indication of the configuration information, so that beam failure recovery on the terminal side and beam failure recovery on the network device side keep consistent to complete beam failure recovery of the SCell.

The configuration information includes at least one of the following:

cell identity information corresponding to the random access resource, such as a PCell identity, an SCell identity, or a serving cell identity corresponding to the PRACH resource;

bandwidth part (Bandwidth Part, BWP) identity information corresponding to the random access resource; and

beam identity information corresponding to the random access resource.

Optionally, the configuration information further includes resource position information for transmitting beam recovery information. To be specific, the network device may configure a resource position for receiving beam recovery information, for example, a resource position of a physical downlink control channel (Physical Downlink Control Channel, PDCCH) for receiving beam recovery information.

In a preferred embodiment, step 12 includes: when the beam failure occurs in the SCell, when the configuration information indicates that the network device has configured a random access resource for beam failure recovery for the SCell, sending a beam failure recovery request message to the network device by using a target random access resource. When detecting a beam failure in an SCell, the terminal triggers a beam failure recovery procedure of the SCell. Based on the configuration information in step 11, the terminal selects a target random access resource (such as a PRACH) of a request message of the beam failure recovery procedure to send a beam failure recovery request message.

Determining a target random access resource includes but is not limited to the following scenarios:

Scenario 1: When a random access resource corresponding to the SCell includes a non-contention based random access resource and a contention-based random access resource, sending a beam failure recovery request message to the network device by using the non-contention based random access resource. To be specific, if the random access resource that is configured by the network device for the SCell and used for transmitting a beam failure recovery request message includes a contention-based random access resource and a non-contention based random access resource, the terminal preferentially uses the non-contention based random access resource.

Scenario 2: When a random access resource is configured in both the SCell and a target cell, sending a beam failure recovery request to the network device by using a first random access resource corresponding to the SCell. The target cell includes at least one of a primary cell PCell and a primary/secondary cell PSCell. To be specific, if the random access resource that is configured by the network device for the SCell and used for transmitting a beam failure recovery request message is configured in both the SpCell and the SCell, the terminal preferentially uses the random access resource in the SCell in which the beam failure occurs. The first random access resource includes a non-contention based random access resource or a contention-based random access resource. Specifically, if “the contention-based random access resource” in the beam failure recovery procedure of the SCell is configured in both the SpCell and the SCell, the terminal preferentially uses “the contention-based random access resource” in the SCell in which the beam failure occurs. If “the non-contention based random access resource” in the beam failure recovery procedure of the SCell is configured in both the SpCell and the SCell, the terminal preferentially uses “the non-contention based random access resource” in the SCell in which the beam failure occurs.

Scenario 2: When a random access resource is configured in both the SCell and a target cell, detecting whether a first random access resource corresponding to the SCell is available, and when the first random access resource is unavailable, sending a beam failure recovery request to the network device by using a second random access resource corresponding to the target cell. The target cell includes a primary cell PCell and a primary/secondary cell PSCell. To be specific, if the random access resource that is configured by the network device for the SCell and used for transmitting a beam failure recovery request message is configured in both the SpCell and the SCell, the terminal needs to detect whether the first random access resource in the SCell is available, and if yes, preferentially uses the first random access resource, or if no, sends a beam failure recovery request to the network device by using the second random access resource corresponding to the target cell. Detecting whether the first random access resource is available may be implemented with reference to the following manner: measuring a beam corresponding to the first random access resource in the SCell, for example, a measurement result of a synchronization signal block (Synchronous Signal Block, SSB), for example, whether reference signal received power (Reference Signal Received Power, RSRP) is higher than a threshold configured by the network device, and if yes, determining that the first random access resource is available, or if no, determining that the first random access resource is unavailable. However, this is not limited.

The first random access resource includes a non-contention based random access resource or a contention-based random access resource, and the second random access resource includes a non-contention based random access resource or a contention-based random access resource. Specifically, if “the contention-based random access resource” in the beam failure recovery procedure of the SCell is configured in both the SpCell and the SCell, the terminal preferentially uses “the contention-based random access resource” in the SCell in which the beam failure occurs. If the terminal detects that “the contention-based random access resource” in the SCell is not available, the terminal sends a beam failure recovery request to the network device by using “the contention-based random access resources” configured in the SpCell. If “the non-contention based random access resource” in the beam failure recovery procedure of the SCell is configured in both the SpCell and the SCell, the terminal preferentially uses “the non-contention based random access resource” in the SCell in which the beam failure occurs. If the terminal detects that “the non-contention based random access resource” in the SCell is not available, the terminal sends a beam failure recovery request to the network device by using “the non-contention based random access resource” configured in the SpCell.

In an exemplary embodiment, after the step of sending a beam failure recovery request message to the network device by using a target random access resource, the method further includes:

if beam recovery indication information fed back by the network device is received in a preset time period, transmitting data by using a target beam indicated by the beam recovery indication information, where when a collision is resolved, for example, after the beam recovery indication information (such as a C-RNTI) sent by the network device is received, the terminal transmits or receives data based on the target beam (a new beam) indicated by the beam recovery indication information, to complete beam recovery; or

if beam recovery indication information fed back by the network device is not received in a preset time period, resending the beam failure recovery request message to the network device, until the beam recovery indication information is received or a quantity of sending times reaches a preset threshold, where the preset time period may be defined by a protocol or configured by the network device; and if the terminal does not receive, in the preset time period (such as a random access response window configured by the network device), the beam recovery indication information sent by the network device, the terminal may resend the beam failure recovery request message, and add 1 to an SCell beam failure recovery counter, until the terminal receives the beam recovery indication information sent by the network device, or the quantity of sending times of the beam failure recovery request message reaches the preset threshold (the SCell beam failure recovery counter reaches a preset threshold).

If the beam recovery indication information sent by the network device is still not received after the quantity of sending times of the beam failure recovery request message reaches the preset threshold, the terminal determines that beam recovery of the SCell fails, and automatically triggers a beam recovery failure processing action of the SCell.

In addition, step 12 further includes:

when the configuration information indicates that the network device has configured a random access resource for beam failure recovery for the SCell, if a random access resource corresponding to the SCell is unavailable, determining not to send a beam failure recovery request message to the network device, and triggering a beam recovery failure processing action of the SCell, where in this scenario, although the network device has configured the random access resource for beam failure recovery for the SCell, when the terminal detects that the random access resource is unavailable, the terminal cannot start the beam failure recovery procedure of the SCell, determines that beam recovery of the SCell fails, and triggers a beam recovery failure processing action of the SCell; or

when the configuration information indicates that the network device has not configured a random access resource for beam failure recovery for the SCell, determining not to send a beam failure recovery request message to the network device, and triggering a beam recovery failure processing action of the SCell, where in this scenario, the network device has not configured any random access resource for beam failure recovery for the SCell, and the terminal cannot start the beam failure recovery procedure of the SCell, determines that beam recovery of the SCell fails, and triggers a beam recovery failure processing action of the SCell.

Preferably, the beam recovery failure processing action includes at least one of the following:

indicating a beam recovery failure to a higher layer, where a MAC layer of the terminal indicates a beam recovery failure of the SCell or a random access failure of the SCell to the higher layer (such as an RRC layer);

indicating a beam recovery failure to a lower layer, where the MAC layer of the terminal indicates a beam recovery failure of the SCell or a random access failure of the SCell to the lower layer (such as a physical PHY layer);

deactivating the SCell, where the MAC layer of the terminal specifically deactivates the SCell;

initiating a radio resource control RRC connection reestablishment procedure, where the higher layer (such as the RRC layer) of the terminal specifically initiates the RRC connection reestablishment procedure;

sending beam failure information of the SCell to the network device, where the higher layer (such as the RRC layer) of the terminal specifically reports the beam failure information of the SCell to the network device; and

stopping measurement corresponding to beam failure detection of the SCell, where the lower layer (such as the physical PHY layer) of the terminal specifically stops measurement corresponding to beam failure detection of the SCell, such as measurement of a channel state information reference signal (Channel State Information Reference Signal, CSI-RS) corresponding to beam failure detection of the SCell.

The beam failure information includes at least one of the following:

beam failure indication information;

beam recovery failure indication information;

a cell identity of the SCell, that is, a cell identity of the SCell in which the beam failure occurs;

a cell measurement result of the SCell, that is, a cell measurement result of the SCell in which the beam failure occurs, such as reference signal received power (Reference Signal Received Power, RSRP), reference signal received quality (Reference Signal Received Quality, RSRQ), or a signal to interference plus noise ratio (Signal to Interference and Noise Ratio, SINR);

a beam measurement result of the SCell, that is, one or more beam measurement results of the SCell in which the beam failure occurs, such as RSRP, reference signal received quality RSRQ, or a signal to interference plus noise ratio SINR of an SSB;

a cell measurement result of another measured serving cell, where the another serving cell includes another serving cell different from the SCell, or another serving cell that is different from the SCell but is in a same cell group (such as an MCG or an SCG) as the SCell, and the cell measurement result herein is a cell measurement result of the another serving cell, such as RSRP, reference signal received quality RSRQ, or a signal to interference plus noise ratio SINR;

a beam measurement result of the another measured serving cell, where the another serving cell includes the another serving cell different from the SCell, or the another serving cell that is different from the SCell but is in the same cell group (such as the MCG or the SCG) as the SCell, and the beam measurement result herein is one or more beam measurement results of the another serving cell, such as RSRP, reference signal received quality RSRQ, or a signal to interference plus noise ratio SINR of an SSB;

a cell measurement result of another measured non-serving cell (such as a neighboring cell), for example, a cell measurement result of the neighboring cell, such as RSRP, reference signal received quality RSRQ, or a signal to interference plus noise ratio SINR; and

a beam measurement result of the another measured non-serving cell, for example, one or more beam measurement results of the neighboring cell, such as RSRP, reference signal received quality RSRQ, or a signal to interference plus noise ratio SINR of an SSB.

The foregoing beam failure recovery request message includes at least one of the following:

beam failure indication information;

identity information of a cell in which a beam failure occurs, such as an identity of the SCell; and

information of a beam that recovers from a beam failure.

The information of the beam includes at least one of beam identity information (such as an SSB identity or a CSI-RS identity) and beam measurement information (such as RSRP, RSRQ, or an SINR).

With reference to a specific procedure, the following further describes a beam recovery procedure of an SCell in which a beam failure occurs in this embodiment.

Using a non-contention based random access resource as an example, as shown in FIG. 2, the method includes the following steps.

Step 21: The terminal receives, from the network device side, configuration information of a random access resource for transmitting a beam failure recovery request message, where the configuration information is used to indicate a non-contention based random access resource configured by the network device for an SCell.

Step 22: When detecting that a beam failure occurs in the SCell, the terminal sends a message 1 (Msg1) to the network device by using the non-contention based random access resource indicated by the configuration information, where the Msg1 includes a random access preamble (Random Access Preamble) and a beam failure recovery request message. After sending the Msg1, the terminal calculates identity information of a scheduling message 2 (Msg2) of the network device based on time of sending the Msg1 and a frequency position for sending the Msg1, such as a random access radio network temporary identifier (Random Access Radio Network Temporary Identifier, RA-RNTI). A specific calculation manner is as follows:

RA-RNTI=1+t_{id}+10*f_{id},

where t_{id} is a time domain identity of a random access signal, such as a subframe identity, and f_{id} is a frequency domain identity of the random access signal.

After sending the Msg1, the terminal monitors a downlink channel in a fixed window, such as a random access response window (Random Access Response window, RAR window), to obtain feedback information (Msg2) of the network device. The RAR window starts at a subframe that contains the end of the Msg1 transmission plus three subframes, and a length of the RAR window is a length configured by the network device.

Step 23: The network device sends a random access response (Random Access Response, RAR) to the terminal, that is, the message 2. The message 2 includes identity information of the Msg1, uplink timing advance information (Timing Advance Command, TAC), uplink grant information (UL Grant), backoff information (Back off Indicator), temporary terminal identity information (Temporary C-RNTI), and beam recovery indication information. If the terminal successfully receives the RAR, the terminal performs beam recovery based on the RAR, and transmits or receives data in a target beam indicated by the RAR. Specifically, after a collision is resolved (for example, a terminal identity C-RNTI indicated by the network side is received), the terminal transmits or receives data by using a new beam based on the beam recovery indication information, to complete beam recovery successfully. If the terminal fails to receive the RAR, the terminal determines, based on the backoff information indicated in the RAR, a time point at which random access is sent next time. Specifically, if the terminal receives, in a preset time period (such as the RAR window configured by the network device) specified by a protocol, no RAR sent by the network device, the terminal resends the beam failure recovery request message based on step 22, and adds 1 to the SCell beam failure recovery counter.

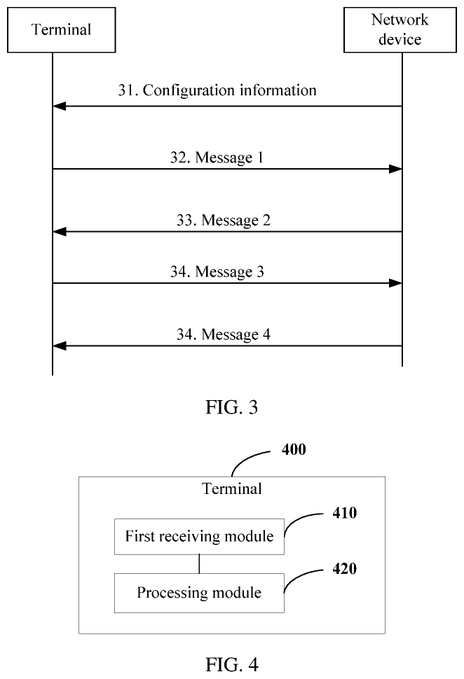

Using a contention-based random access resource as an example, as shown in FIG. 3, the method includes the following steps.

Step 31: The terminal receives, from the network device side, configuration information of a random access resource for transmitting a beam failure recovery request message, where the configuration information is used to indicate a contention-based random access resource configured by the network device for an SCell.

Step 32: When the terminal detects that a beam failure occurs in the SCell, the terminal selects a random access resource in the contention-based random access resource indicated by the configuration information, and sends a message 1 (Msg1) to the network device by using the selected random access resource. After sending the Msg1, the terminal calculates identity information of a scheduling message 2 (Msg2) of the network device based on time of sending the Msg1 and a frequency position for sending the Msg1, such as an RA-RNT. A manner of calculating the RA-RNTI and an RAR window is similar to that of a non-contention based random access process, and is not described again.

Step 33: After receiving the Msg1, the network device calculates a timing advance TA based on the Msg1, and sends a random access response RAR to the terminal, where the random access response includes at least information about the timing advance and a UL grant for a message 3 (Msg3).

Step 34: The terminal sends uplink transmission on the UL grant specified by the Msg2. For random access of different functions, content of uplink transmission in the Msg3 is different. For example, for initial access, an RRC connection establishment request is transmitted in the Msg3. For a beam failure recovery procedure, the Msg3 includes a beam failure recovery request message.

Step 35: After receiving the Msg3, the network device responds to a service request carried in the Msg3, and feeds back a resolution result to the terminal, that is, a message 4 (Msg4). Specifically, the Msg4 includes beam recovery indication information. After a collision is resolved (for example, a terminal identity C-RNTI indicated by the network side is received) based on the beam recovery indication information from the network device, the terminal transmits or receives data by using a new beam based on the beam recovery indication information, to complete beam recovery successfully. If the terminal fails to receive the RAR, the terminal determines, based on backoff information indicated in the RAR, a time point at which random access is sent next time. Specifically, if the terminal receives, in a preset time period (such as the RAR window configured by the network device) specified by a protocol, no RAR sent by the network device, the terminal resends the beam failure recovery request message based on step 22, and adds 1 to the SCell beam failure recovery counter.

In the beam failure processing method in this embodiment of this disclosure, the network device indicates, by using configuration information, whether a random access resource for beam failure recovery has been configured for the SCell of the terminal; and when the terminal detects that a beam failure occurs in the SCell, the terminal initiates a beam failure recovery procedure based on an indication of the configuration information, so that beam failure recovery on the terminal side and beam failure recovery on the network device side keep consistent to complete beam failure recovery of the SCell.

The beam failure processing method in different scenarios is described in the foregoing embodiment. With reference to an accompanying drawing, the following further describes a terminal corresponding to the beam failure processing method.

As shown in FIG. 4, a terminal 400 in an embodiment of this disclosure can implement details of the method in the foregoing embodiment, that is, receiving, from a network device side, configuration information of a random access resource for transmitting a beam failure recovery request message, and when a beam failure occurs in an SCell, determining, based on an indication of the configuration information, whether to send a beam failure recovery request message to the network device, and can achieve a same effect. The terminal 400 specifically includes the following functional modules:

a first receiving module 410, configured to receive, from a network device side, configuration information of a random access resource for transmitting a beam failure recovery request message, where the configuration information is used to indicate whether the network device has configured the random access resource for a secondary cell SCell; and

a processing module 420, configured to: when a beam failure occurs in the SCell, determine, based on an indication of the configuration information, whether to send a beam failure recovery request message to the network device.

The configuration information includes at least one of the following:

cell identity information corresponding to the random access resource;

bandwidth part BWP identity information corresponding to the random access resource; and

beam identity information corresponding to the random access resource.

The configuration information further includes resource position information for transmitting beam recovery information.

The processing module 420 includes:

a first processing submodule, configured to: when the configuration information indicates that the network device has configured a random access resource for beam failure recovery for the SCell, send a beam failure recovery request message to the network device by using a target random access resource.

The first processing submodule includes:

a first processing unit, configured to: when a random access resource corresponding to the SCell includes a non-contention based random access resource and a contention-based random access resource, send a beam failure recovery request message to the network device by using the non-contention based random access resource; or

a second processing unit, configured to: when a random access resource is configured in both the SCell and a target cell, send a beam failure recovery request to the network device by using a first random access resource corresponding to the SCell, where the target cell includes at least one of a primary cell PCell and a primary/secondary cell PSCell; or

a third processing unit, configured to: when a random access resource is configured in both the SCell and a target cell, detect whether a first random access resource corresponding to the SCell is available, and when the first random access resource is unavailable, send a beam failure recovery request to the network device by using a second random access resource corresponding to the target cell.

The first random access resource includes a non-contention based random access resource or a contention-based random access resource, and the second random access resource includes a non-contention based random access resource or a contention-based random access resource.

The processing module 420 further includes:

a second processing submodule, configured to: if beam recovery indication information fed back by the network device is received in a preset time period, transmit data by using a target beam indicated by the beam recovery indication information; or

a third processing submodule, configured to: if beam recovery indication information fed back by the network device is not received in a preset time period, resend the beam failure recovery request message to the network device, until the beam recovery indication information is received or a quantity of sending times reaches a preset threshold.

The terminal further includes:

a triggering module, configured to trigger a beam recovery failure processing action of the SCell after the quantity of sending times reaches the preset threshold.

The processing module further includes:

a fourth processing submodule, configured to: when the configuration information indicates that the network device has configured a random access resource for beam failure recovery for the SCell, if a random access resource corresponding to the SCell is unavailable, determine not to send a beam failure recovery request message to the network device, and trigger a beam recovery failure processing action of the SCell; or

a fifth processing submodule, configured to: when the configuration information indicates that the network device has not configured a random access resource for beam failure recovery for the SCell, determine not to send a beam failure recovery request message to the network device, and trigger a beam recovery failure processing action of the SCell.

The beam recovery failure processing action includes at least one of the following:

indicating a beam recovery failure to a higher layer;

indicating a beam recovery failure to a lower layer;

deactivating the SCell;

initiating a radio resource control RRC connection reestablishment procedure;

sending beam failure information of the SCell to the network device; and

stopping measurement corresponding to beam failure detection of the SCell.

The beam failure information includes at least one of the following:

beam failure indication information;

beam recovery failure indication information;

a cell identity of the SCell;

a cell measurement result of the SCell;

a beam measurement result of the SCell;

a cell measurement result of another measured serving cell;

a beam measurement result of the another measured serving cell;

a cell measurement result of another measured non-serving cell; and

a beam measurement result of the another measured non-serving cell.

The another serving cell includes another serving cell that is in a same cell group as the SCell.

The beam failure recovery request message includes at least one of the following:

beam failure indication information;

identity information of a cell in which a beam failure occurs; and

information of a beam that recovers from a beam failure.

The information of the beam includes at least one of beam identity information and beam measurement information.

It should be noted that the terminal in this embodiment of this disclosure receives configuration information sent by the network device, to determine whether a random access resource for beam failure recovery has been configured for the SCell; and when the terminal detects that a beam failure occurs in the SCell, the terminal initiates a beam failure recovery procedure based on an indication of the configuration information, so that beam failure recovery on the terminal side and beam failure recovery on the network device side keep consistent to complete beam failure recovery of the SCell.

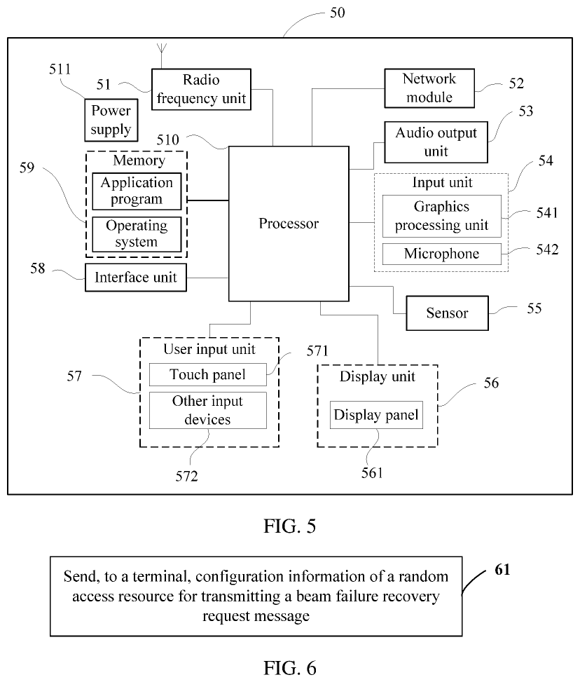

To better achieve the foregoing objective, further, FIG. 5 is a schematic diagram of a hardware structure of a terminal for implementing each embodiment of this disclosure. The terminal 50 includes but is not limited to components such as a radio frequency unit 51, a network module 52, an audio output unit 53, an input unit 54, a sensor 55, a display unit 56, a user input unit 57, an interface unit 58, a memory 59, a processor 510, and a power supply 511. A person skilled in the art may understand that the structure of the terminal shown in FIG. 5 does not constitute a limitation on the terminal. A quantity of components included in the terminal may be greater or less than that shown in the figure, or some components are combined, or component arrangements are different. In this embodiment of this disclosure, the terminal includes but is not limited to a mobile phone, a tablet computer, a notebook computer, a palmtop computer, an in-vehicle terminal, a wearable device, a pedometer, or the like.

The radio frequency unit 51 is configured to receive, from a network device side, configuration information of a random access resource for transmitting a beam failure recovery request message, where the configuration information is used to indicate whether the network device has configured the random access resource for a secondary cell SCell.

The processor 510 is configured to: when a beam failure occurs in the SCell, determine, based on an indication of the configuration information, whether to send a beam failure recovery request message to the network device.

The terminal in this embodiment of this disclosure receives configuration information sent by the network device, to determine whether a random access resource for beam failure recovery has been configured for the SCell; and when the terminal detects that a beam failure occurs in the SCell, the terminal initiates a beam failure recovery procedure based on an indication of the configuration information, so that beam failure recovery on the terminal side and beam failure recovery on the network device side keep consistent to complete beam failure recovery of the SCell.

It should be understood that in this embodiment of this disclosure, the radio frequency unit 51 may be configured to receive and send signals in an information reception or transmission or call process. Specifically, after receiving downlink data from a base station, the radio frequency unit 51 sends the downlink data to the processor 510 for processing, and in addition, sends uplink data to the base station. Generally, the radio frequency unit 51 includes but is not limited to an antenna, at least one amplifier, a transceiver, a coupler, a low noise amplifier, a duplexer, and the like. In addition, the radio frequency unit 51 may further communicate with a network and another device through a wireless communications system.

The terminal provides wireless broadband Internet access for a user by using the network module 52, for example, helps the user send and receive e-mails, browse web pages, and access streaming media.

The audio output unit 53 may convert audio data received by the radio frequency unit 51 or the network module 52 or stored in the memory 59 into an audio signal, and output the audio signal as a sound. In addition, the audio output unit 53 may further provide an audio output (for example, a call signal reception sound or a message reception sound) related to a specific function performed by the terminal 50. The audio output unit 53 includes a speaker, a buzzer, a telephone receiver, and the like.

The input unit 54 is configured to receive an audio or video signal. The input unit 54 may include a graphics processing unit (Graphics Processing Unit, GPU) 541 and a microphone 542. The graphics processing unit 541 processes image data of a still picture or a video obtained by an image capture apparatus (for example, a camera) in an image capture mode or a video capture mode. A processed image frame may be displayed on the display unit 56. An image frame processed by the graphics processing unit 541 may be stored in the memory 59 (or another storage medium) or sent by the radio frequency unit 51 or the network module 52. The microphone 542 can receive a sound and can process the sound into audio data. The processed audio data may be converted in a telephone call mode into a format that can be sent by the radio frequency unit 51 to a mobile communications base station, for outputting.

The terminal 50 further includes at least one sensor 55, for example, a light sensor, a motion sensor, and another sensor. Specifically, the light sensor includes an ambient light sensor and a proximity sensor. The ambient light sensor may adjust luminance of a display panel 561 based on brightness of ambient light. The proximity sensor may turn off and/or backlight the display panel 561 when the terminal 50 moves to an ear. As a type of motion sensor, an accelerometer sensor may detect acceleration magnitudes in all directions (generally three axes), and when the accelerometer sensor is stationary, may detect a magnitude and a direction of gravity, and may be configured to recognize a posture of the terminal (such as switching between landscape and portrait, related games, and magnetometer posture calibration), vibration recognition related functions (such as a pedometer and stroke), and the like. The sensor 55 may further include a fingerprint sensor, a pressure sensor, an iris sensor, a molecular sensor, a gyroscope, a barometer, a hygrometer, a thermometer, an infrared sensor, and the like. Details are not described herein.

The display unit 56 is configured to display information input by the user or information provided for the user. The display unit 56 may include the display panel 561. The display panel 561 may be configured in a form of a liquid crystal display (Liquid Crystal Display, LCD), an organic light-emitting diode (Organic Light-Emitting Diode, OLED), or the like.

The user input unit 57 may be configured to receive input digit or character information, and generate a key signal input related to a user setting and function control of the terminal. Specifically, the user input unit 57 includes a touch panel 571 and other input devices 572. The touch panel 571, also referred to as a touchscreen, may capture a touch operation performed by the user on or near the touch panel (for example, an operation performed by the user on the touch panel 571 or near the touch panel 571 by using any appropriate object or accessory such as a finger or a stylus). The touch panel 571 may include two parts: a touch detection apparatus and a touch controller. The touch detection apparatus detects a touch direction of the user, detects a signal carried by a touch operation, and transmits the signal to the touch controller. The touch controller receives touch information from the touch detection apparatus, converts the touch information into point coordinates, sends the point coordinates to the processor 510, and receives and executes a command sent by the processor 510. In addition, the touch panel 571 may be implemented in a plurality of forms, for example, a resistive, capacitive, infrared, or surface acoustic wave touch panel. The user input unit 57 may further include the other input devices 572 in addition to the touch panel 571. Specifically, the other input devices 572 may include but are not limited to a physical keyboard, a function key (such as a volume control key or a power on/off key), a trackball, a mouse, a joystick, and the like. Details are not described herein.

Further, the touch panel 571 may cover the display panel 561. After the touch panel 571 detects a touch operation on or near the touch panel, the touch panel 571 transmits the touch operation to the processor 510 to determine a type of a touch event. Then the processor 510 provides a corresponding visual output on the display panel 561 based on the type of the touch event. Although the touch panel 571 and the display panel 561 are used as two independent components to implement input and output functions of the terminal in FIG. 5, the touch panel 571 and the display panel 561 may be integrated to implement the input and output functions of the terminal in some embodiments. This is not specifically limited herein.

The interface unit 58 is an interface for connecting an external apparatus to the terminal 50. For example, the external apparatus may include a wired or wireless headphone port, an external power (or battery charger) port, a wired or wireless data port, a memory card port, a port for connecting an apparatus having an identification module, an audio input/output (I/O) port, a video I/O port, an earphone port, and the like. The interface unit 58 may be configured to receive an input (for example, data information or power) from an external apparatus, and transmit the received input to one or more components in the terminal 50, or may be configured to transmit data between the terminal 50 and an external apparatus.

The memory 59 may be configured to store a software program and various data. The memory 59 may mainly include a program storage area and a data storage area. The program storage area may store an operating system, an application program required for at least one function (such as a sound play function and an image play function), and the like. The data storage area may store data created based on use of the terminal (such as audio data and a phone book), and the like. In addition, the memory 59 may include a high-speed random access memory, or may include a non-volatile memory, for example, at least one magnetic disk storage device or a flash memory, or other volatile solid-state storage devices.

The processor 510 is a control center of the terminal. The processor 59 uses various interfaces and lines to connect all parts of the entire terminal, and performs various functions and data processing of the terminal by running or executing the software program and/or module stored in the memory 59 and invoking data stored in the memory 59, thereby performing overall monitoring on the terminal. The processor 510 may include one or more processing units. Preferably, the processor 510 may integrate an application processor and a modem processor. The application processor mainly processes the operating system, a user interface, an application program, and the like. The modem processor mainly processes wireless communication. It may be understood that the modem processor may alternatively not be integrated into the processor 510.

The terminal 50 may further include the power supply 511 (such as a battery) supplying power to each component. Preferably, the power supply 511 may be logically connected to the processor 510 by using a power management system, so that functions such as charge and discharge management and power consumption management are implemented by using the power management system.

In addition, the terminal 50 includes some functional modules that are not illustrated. Details are not described herein.

Preferably, an embodiment of this disclosure further provides a terminal, including a processor 510, a memory 59, and a computer program stored in the memory 59 and capable of running on the processor 510. When the computer program is executed by the processor 510, each process of the foregoing embodiment of the beam failure processing method is implemented, and a same technical effect can be achieved. To avoid repetition, details are not described again herein. The terminal may be a wireless terminal or a wired terminal. The wireless terminal may be a device that provides a user with voice and/or other service data connectivity, a handheld device with a wireless connection function, or another processing device connected to a wireless modem. The wireless terminal may communicate with one or more core networks through a radio access network (Radio Access Network, RAN for short). The wireless terminal may be a mobile terminal, such as a mobile phone (also referred to as a “cellular” phone) and a computer with a mobile terminal, for example, may be a portable, pocket-sized, handheld, computer built-in, or in-vehicle mobile apparatus, which exchanges voice and/or data with the radio access network. For example, it may be a device such as a personal communication service (Personal Communication Service, PCS for short) phone, a cordless telephone set, a Session Initiation Protocol (Session Initiation Protocol, SIP for short) phone, a wireless local loop (Wireless Local Loop, WLL for short) station, or a personal digital assistant (Personal Digital Assistant, PDA for short). The wireless terminal may also be referred to as a system, a subscriber unit (Subscriber Unit), a subscriber station (Subscriber Station), a mobile station (Mobile Station), a remote station (Remote Station), a remote terminal (Remote Terminal), an access terminal (Access Terminal), a user terminal (User Terminal), a user agent (User Agent), or a user device (User Device or User Equipment). This is not limited herein.

An embodiment of this disclosure further provides a computer-readable storage medium, where the computer-readable storage medium stores a computer program. When the computer program is executed by a processor, each process of the foregoing embodiment of the beam failure processing method is implemented, and a same technical effect can be achieved. To avoid repetition, details are not described again herein. The computer-readable storage medium is, for example, a read-only memory (Read-Only Memory, ROM for short), a random access memory (Random Access Memory, RAM for short), a magnetic disk, or an optical disc.

The beam failure processing method on the terminal side is described in the foregoing embodiment of this disclosure. The following further describes a beam failure processing method on a network device side with reference to an accompanying drawing.

As shown in FIG. 6, a beam failure processing method in an embodiment of this disclosure is applied to a network device side, and includes the following step.

Step 61: Send, to a terminal, configuration information of a random access resource for transmitting a beam failure recovery request message.

The configuration information is used to indicate whether the random access resource is configured for a secondary cell SCell of the terminal.

The configuration information includes at least one of the following:

cell identity information corresponding to the random access resource;

bandwidth part BWP identity information corresponding to the random access resource; and

beam identity information corresponding to the random access resource.

The configuration information further includes resource position information for transmitting beam recovery information. For one or more SCells of the terminal, the network device configures a resource used for a beam failure recovery request message. Herein, the random access resource includes a PRACH resource that is reserved by the network device for the terminal and used for transmitting a beam failure recovery request. Herein, the random access resource may be a non-contention based random access resource (such as a PRACH resource configured by dedicated PRACH-Config) or may be a contention-based random access resource (such as a PRACH resource configured by common PRACH-Config).

After step 61, the method further includes: receiving a beam failure recovery request that is sent by the terminal with respect to the SCell by using a target random access resource.

The beam failure recovery request message includes at least one of the following:

beam failure indication information;

identity information of a cell in which a beam failure occurs, such as an identity of the SCell; and

information of a beam that recovers from a beam failure.

The information of the beam includes at least one of beam identity information (such as an SSB identity or a CSI-RS identity) and beam measurement information (such as RSRP, RSRQ, or an SINR).

After the step of receiving a beam failure recovery request that is sent by the terminal with respect to the SCell by using a target random access resource, the method further includes: determining, based on the beam failure recovery request, whether to feed back beam recovery indication information to the terminal. Correspondingly, if the beam recovery indication information fed back by the network device is received in a preset time period, the terminal transmits data by using a target beam indicated by the beam recovery indication information; or if the beam recovery indication information fed back by the network device is not received in a preset time period, the terminal resends the beam failure recovery request message to the network device, until the beam recovery indication information is received or a quantity of sending times reaches a preset threshold. If the beam recovery indication information sent by the network device is still not received after the quantity of sending times of the beam failure recovery request message reaches the preset threshold, the terminal determines that beam recovery of the SCell fails, and automatically triggers a beam recovery failure processing action of the SCell.

After step 61, the method further includes: receiving beam failure information of the SCell from the terminal side. A higher layer (such as an RRC layer) of the terminal reports the beam failure information of the SCell to the network device.

The beam failure information includes at least one of the following:

beam failure indication information;

beam recovery failure indication information;

a cell identity of the SCell;

a cell measurement result of the SCell;

a beam measurement result of the SCell;

a cell measurement result of another measured serving cell;

a beam measurement result of the another measured serving cell;

a cell measurement result of another measured non-serving cell; and

a beam measurement result of the another measured non-serving cell.

The another serving cell includes another serving cell that is in a same cell group as the SCell.

In the beam failure processing method in this embodiment of this disclosure, the network device indicates, by using configuration information, whether a random access resource for beam failure recovery has been configured for the SCell of the terminal; and when the terminal detects that a beam failure occurs in the SCell, the terminal initiates a beam failure recovery procedure based on an indication of the configuration information, so that beam failure recovery on the terminal side and beam failure recovery on the network device side keep consistent to complete beam failure recovery of the SCell.

The beam failure processing method in different scenarios is separately described in detail in the foregoing embodiment. A network device corresponding to the beam failure processing method is further described in the following embodiment with reference to an accompanying drawing.

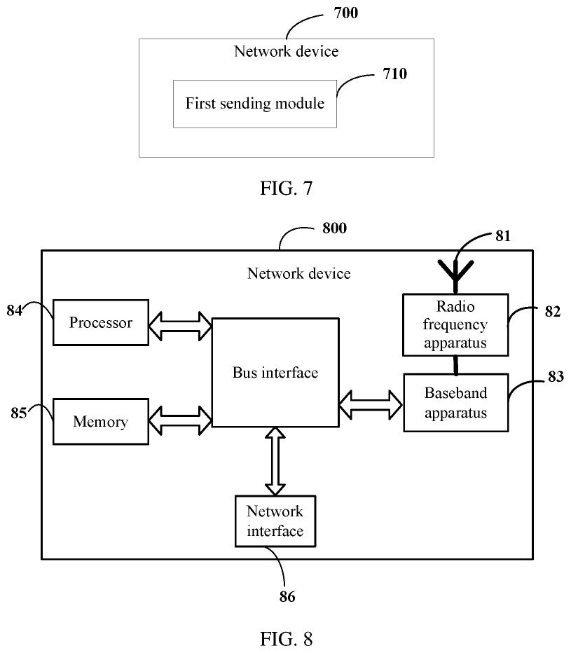

As shown in FIG. 7, a network device 700 in an embodiment of this disclosure can implement details of the method in the foregoing embodiment, that is, sending, to a terminal, configuration information of a random access resource for transmitting a beam failure recovery request message, and can achieve a same effect, where the configuration information is used to indicate whether the random access resource is configured for a secondary cell SCell of the terminal. The network device 700 specifically includes the following functional module:

a first sending module 710, configured to send, to a terminal, configuration information of a random access resource for transmitting a beam failure recovery request message, where the configuration information is used to indicate whether the random access resource is configured for a secondary cell SCell of the terminal.

The configuration information includes at least one of the following:

cell identity information corresponding to the random access resource;

bandwidth part BWP identity information corresponding to the random access resource; and

beam identity information corresponding to the random access resource.

The configuration information further includes resource position information for transmitting beam recovery information.

After the step of sending, to a terminal, configuration information of a random access resource for transmitting a beam failure recovery request message, the method further includes:

receiving a beam failure recovery request that is sent by the terminal with respect to the SCell by using a target random access resource.

After the step of receiving a beam failure recovery request that is sent by the terminal with respect to the SCell by using a target random access resource, the method further includes:

determining, based on the beam failure recovery request, whether to feed back beam recovery indication information to the terminal.

After the step of sending, to a terminal, configuration information of a random access resource for transmitting a beam failure recovery request message, the method further includes:

receiving beam failure information of the SCell from the terminal side.

The beam failure information includes at least one of the following:

beam failure indication information;

beam recovery failure indication information;

a cell identity of the SCell;

a cell measurement result of the SCell;

a beam measurement result of the SCell;

a cell measurement result of another measured serving cell;

a beam measurement result of the another measured serving cell;

a cell measurement result of another measured non-serving cell; and

a beam measurement result of the another measured non-serving cell.

The another serving cell includes another serving cell that is in a same cell group as the SCell.

The beam failure recovery request message includes at least one of the following:

beam failure indication information;

identity information of a cell in which a beam failure occurs; and

information of a beam that recovers from a beam failure.

The information of the beam includes at least one of beam identity information and beam measurement information.

It should be understood that division of modules of the network device and the terminal is merely logical function division. The modules may be all or partially integrated in a physical entity or may be separated physically in an actual implementation. In addition, the modules may be all implemented in a form of software invoked by a processing component, or may be all implemented in a form of hardware; or a part of modules may be implemented in a form of software invoked by a processing component, and another part of modules may be implemented in a form of hardware. For example, a determining module may be a processing component that is separately disposed, or may be integrated in a chip of the apparatus for implementation. In addition, the determining module may be stored in the memory of the apparatus in a form of program code, and is invoked by a processing component of the apparatus to perform a function of the determining module. Implementation of other modules is similar to this. In addition, the modules may be all or partially integrated, or may be implemented independently. Herein, the processing component may be an integrated circuit, and has a signal processing capability. In an implementation process, steps in the foregoing method or the foregoing modules can be implemented by using a hardware integrated logical circuit in the processor component, or by using instructions in a form of software.

For example, the modules may be configured as one or more integrated circuits for implementing the foregoing method, for example, one or more application-specific integrated circuits (Application-Specific Integrated Circuit, ASIC for short), or one or more microprocessors (digital signal processor, DSP for short), or one or more field programmable gate arrays (Field Programmable Gate Array, FPGA for short). For another example, when one of the foregoing modules is implemented in a form of program code invoked by the processing component, the processing component may be a general processor, for example, a central processing unit (Central Processing Unit, CPU for short) or another processor that may invoke program code. For another example, the modules may be integrated and implemented in a form of a system-on-a-chip (system-on-a-chip, SOC for short).

It should be noted that the network device in this embodiment of this disclosure indicates, by using configuration information, whether a random access resource for beam failure recovery has been configured for the SCell of the terminal; and when the terminal detects that a beam failure occurs in the SCell, the terminal initiates a beam failure recovery procedure based on an indication of the configuration information, so that beam failure recovery on the terminal side and beam failure recovery on the network device side keep consistent to complete beam failure recovery of the SCell.

To better achieve the foregoing objective, an embodiment of this disclosure further provides a network device, including a processor, a memory, and a computer program stored in the memory and capable of running on the processor, where when the processor executes the computer program, steps of the foregoing beam failure processing method are implemented. An embodiment of the present disclosure further provides a computer-readable storage medium, where the computer-readable storage medium stores a computer program, and when the computer program is executed by a processor, steps of the foregoing beam failure processing method are implemented.

Specifically, an embodiment of this disclosure further provides a network device. As shown in FIG. 8, the network device 800 includes an antenna 81, a radio frequency apparatus 82, and a baseband apparatus 83. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes to-be-sent information, and sends the information to the radio frequency apparatus 82; and the radio frequency apparatus 82 processes the received information and then sends the information out by using the antenna 81.

The radio frequency apparatus 82 may be located in the baseband apparatus 83. The method performed by the network device in the foregoing embodiment may be implemented in the baseband apparatus 83, and the baseband apparatus 83 includes a processor 84 and a memory 85.

The baseband apparatus 83 may include, for example, at least one baseband processing unit, where a plurality of chips are disposed on the baseband processing unit. As shown in FIG. 8, one of the chips is, for example, the processor 84, connected to the memory 85, to invoke a program in the memory 85 to perform the operation of the network device shown in the foregoing method embodiment.

The baseband apparatus 83 may further include a network interface 86, configured to exchange information with the radio frequency apparatus 82, where the interface is, for example, a common public radio interface (common public radio interface, CPRI for short).

Herein, the processor may be one processor, or may be a collective term for a plurality of processing components. For example, the processor may be a CPU, or may be an ASIC, or is configured as one or more integrated circuits for implementing the method performed by the network device, for example, one or more microprocessors DSPs, or one or more field programmable gate arrays FPGAs. A storage component may be a memory, or may be a collective term for a plurality of storage components.

The memory 85 may be a volatile memory or a non-volatile memory, or may include a volatile memory and a non-volatile memory. The non-volatile memory may be a read-only memory (Read-Only Memory, ROM for short), a programmable read-only memory (Programmable ROM, PROM for short), an erasable programmable read-only memory (Erasable PROM, EPROM for short), an electrically erasable programmable read-only memory (Electrically EPROM, EEPROM for short), or a flash memory. The volatile memory may be a random access memory (Random Access Memory, RAM for short), which is used as an external cache. For example but not for restrictive description, a plurality of forms of RAMs such as a static random access memory (Static RAM, SRAM for short), a dynamic random access memory (Dynamic RAM, DRAM for short), a synchronous dynamic random access memory (Synchronous DRAM, SDRAM for short), a double data rate synchronous dynamic random access memory (Double Data Rate SDRAM, DDR SDRAM for short), an enhanced synchronous dynamic random access memory (Enhanced SDRAM, ESDRAM for short), a synchlink dynamic random access memory (Synchlink DRAM, SLDRAM for short), and a direct rambus random access memory (Direct Rambus RAM, DRRAM for short) may be used. The memory 85 described in this application is intended to include but is not limited to these and any other suitable types of memories.

Specifically, the network device in this embodiment of this disclosure further includes a computer program stored in the memory 85 and capable of running on the processor 84. The processor 84 invokes the computer program in the memory 85 to perform the method performed by the module shown in FIG. 7.

Specifically, when being invoked by the processor 84, the computer program may be configured to send, to a terminal, configuration information of a random access resource for transmitting a beam failure recovery request message, where the configuration information is used to indicate whether the random access resource is configured for a secondary cell SCell of the terminal.

The configuration information includes at least one of the following:

cell identity information corresponding to the random access resource;

bandwidth part BWP identity information corresponding to the random access resource; and

beam identity information corresponding to the random access resource.

The configuration information further includes resource position information for transmitting beam recovery information.

Specifically, when being invoked by the processor 84, the computer program may be configured to receive a beam failure recovery request that is sent by the terminal with respect to the SCell by using a target random access resource.

Specifically, when being invoked by the processor 84, the computer program may be configured to determine, based on the beam failure recovery request, whether to feed back beam recovery indication information to the terminal.

Specifically, when being invoked by the processor 84, the computer program may be configured to receive beam failure information of the SCell from the terminal side.

The beam failure information includes at least one of the following:

beam failure indication information;

beam recovery failure indication information;

a cell identity of the SCell;

a cell measurement result of the SCell;

a beam measurement result of the SCell;

a cell measurement result of another measured serving cell;

a beam measurement result of the another measured serving cell;

a cell measurement result of another measured non-serving cell; and

a beam measurement result of the another measured non-serving cell.

The another serving cell includes another serving cell that is in a same cell group as the SCell.

The beam failure recovery request message includes at least one of the following:

beam failure indication information;

identity information of a cell in which a beam failure occurs; and

information of a beam that recovers from a beam failure.

The information of the beam includes at least one of beam identity information and beam measurement information.

The network device may be a base transceiver station (Base Transceiver Station, BTS for short) in a Global System for Mobile Communications (Global System for Mobile Communications, GSM for short) or Code Division Multiple Access (Code Division Multiple Access, CDMA for short), or may be a NodeB (NodeB, NB for short) in Wideband Code Division Multiple Access (Wideband Code Division Multiple Access, WCDMA for short), or may be an evolved NodeB (Evolved NodeB, eNB or eNodeB for short), a relay station, or an access point in LTE, or may be a base station in a future 5G network, or the like, and is not limited herein.

The network device in this embodiment of this disclosure indicates, by using configuration information, whether a random access resource for beam failure recovery has been configured for the SCell of the terminal; and when the terminal detects that a beam failure occurs in the SCell, the terminal initiates a beam failure recovery procedure based on an indication of the configuration information, so that beam failure recovery on the terminal side and beam failure recovery on the network device side keep consistent to complete beam failure recovery of the SCell.

A person of ordinary skill in the art may be aware that the units and algorithm steps in the examples described with reference to the embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described again herein.

In the embodiments provided in this application, it should be understood that the disclosed apparatus and method may be implemented in other manners. For example, the described apparatus embodiment is merely an example. For example, the unit division is merely logical function division and may be other division in actual implementation. For example, a plurality of units or components may be combined or integrated into another system, or some features may be ignored or may not be performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network elements. Some or all of the units may be selected based on actual requirements to achieve the objectives of the solutions of the embodiments.

In addition, functional units in the embodiments of this disclosure may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this disclosure essentially, or the part contributing to the prior art, or some of the technical solutions may be embodied in a form of a computer software product. The computer software product is stored in a storage medium, and includes several instructions for instructing a computer device (which may be a personal computer, a server, a network device, or the like) to perform all or some of the steps of the methods described in the embodiments of this disclosure. The foregoing storage medium includes: any medium that can store program code, such as a USB flash drive, a removable hard disk, a ROM, a RAM, a magnetic disk, or an optical disc.

In addition, it should be noted that in the apparatus and method of this disclosure, apparently, the components or steps may be decomposed and/or recombined. The decomposition and/or recombination should be considered as an equivalent solution of this disclosure. In addition, steps for performing the foregoing series of processing may be naturally performed in a sequence of description and in a time sequence, but do not need to be performed necessarily in the time sequence, and some steps may be performed in parallel or independently. A person of ordinary skill in the art can understand that all or any steps or components of the method and apparatus in this disclosure may be implemented by hardware, firmware, software, or a combination thereof in any computing apparatus (including a processor, a storage medium, and the like) or a network of a computing apparatus. This can be implemented as long as a person of ordinary skill in the art applies basic programming skill after reading the specification of this disclosure.

Therefore, an objective of this disclosure may also be achieved by running a program or a group of programs on any computing apparatus. The computing apparatus may be a well-known general apparatus. Therefore, the objective of this disclosure may also be achieved by merely providing a program product including program code for implementing the method or apparatus. To be specific, the program product also constitutes this disclosure, and a storage medium storing the program product also constitutes this disclosure. Apparently, the storage medium may be any well-known storage medium or any storage medium that will be developed in the future. It should also be noted that in the apparatus and method of this disclosure, apparently, the components or steps may be decomposed and/or recombined. The decomposition and/or recombination should be considered as an equivalent solution of this disclosure. In addition, steps for performing the foregoing series of processing may be naturally performed in a sequence of description and in a time sequence, but do not need to be performed necessarily in the time sequence. Some steps may be performed in parallel or independently.

The foregoing descriptions are preferred implementations of this disclosure. It should be noted that a person of ordinary skill in the art may make several improvements or refinements without departing from the principle of this disclosure and the improvements or refinements shall fall within the protection scope of this disclosure.

1. A beam failure processing method, applied to a terminal, comprising:
receiving, from a network device, configuration information of a random access resource for transmitting a beam failure recovery request message; and
when a beam failure occurs in the SCell, determining, based on an indication of the configuration information, whether to send a beam failure recovery request message to the network device.

2. The beam failure processing method according to claim 1, wherein the configuration information is used to indicate whether the network device has configured the random access resource for a secondary cell SCell;
wherein the step of determining, based on an indication of the configuration information, whether to send a beam failure recovery request message to the network device comprises:
when the configuration information indicates that the network device has configured a random access resource for beam failure recovery for the SCell, sending a beam failure recovery request message to the network device by using a target random access resource.

3. The beam failure processing method according to claim 2, wherein the step of sending a beam failure recovery request message to the network device by using a target random access resource comprises:
when a random access resource corresponding to the SCell comprises a non-contention based random access resource and a contention-based random access resource, sending a beam failure recovery request message to the network device by using the non-contention based random access resource; or
when a random access resource is configured in both the SCell and a target cell, sending a beam failure recovery request to the network device by using a first random access resource corresponding to the SCell, wherein the target cell comprises at least one of a primary cell (PCell) and a primary secondary cell (PSCell); or
when a random access resource is configured in both the SCell and a target cell, detecting whether a first random access resource corresponding to the SCell is available, and when the first random access resource is unavailable, sending a beam failure recovery request to the network device by using a second random access resource corresponding to the target cell;
wherein the first random access resource comprises a non-contention based random access resource or a contention-based random access resource, and the second random access resource comprises a non-contention based random access resource or a contention-based random access resource.

4. The beam failure processing method according to claim 2, wherein after the step of sending a beam failure recovery request message to the network device by using a target random access resource, the method further comprises:
if beam recovery indication information fed back by the network device is received in a preset time period, transmitting or receiving data by using a target beam indicated by the beam recovery indication information; or
if beam recovery indication information fed back by the network device is not received in the preset time period, resending the beam failure recovery request message to the network device, until the beam recovery indication information is received or a quantity of sending times reaches a preset threshold;
wherein after the quantity of sending times reaches the preset threshold, the beam failure processing method further comprises:
triggering a beam recovery failure processing action of the SCell.

5. The beam failure processing method according to claim 1, wherein the step of determining, based on an indication of the configuration information, whether to send a beam failure recovery request message to the network device comprises:
when the configuration information indicates that the network device has configured a random access resource for beam failure recovery for the SCell, if a random access resource corresponding to the SCell is unavailable, determining not to send a beam failure recovery request message to the network device, and triggering a beam recovery failure processing action of the SCell; or
when the configuration information indicates that the network device has not configured a random access resource for beam failure recovery for the SCell, determining not to send a beam failure recovery request message to the network device, and triggering a beam recovery failure processing action of the SCell;
wherein the beam recovery failure processing action comprises at least one of the following:
indicating a beam recovery failure to a higher layer;
indicating a beam recovery failure to a lower layer;
deactivating the SCell;
initiating a radio resource control RRC connection reestablishment procedure;
sending beam failure information of the SCell to the network device; and
stopping measurement corresponding to beam failure detection of the SCell;
wherein the beam failure information comprises at least one of the following:
beam failure indication information;
beam recovery failure indication information;
a cell identity of the SCell;
a cell measurement result of the SCell;
a beam measurement result of the SCell;
a cell measurement result of another measured serving cell;
a beam measurement result of the another measured serving cell;
a cell measurement result of another measured non-serving cell; and
a beam measurement result of the another measured non-serving cell.

6. The beam failure processing method according to claim 1, wherein the configuration information comprises at least one of the following:
cell identity information corresponding to the random access resource;
bandwidth part BWP identity information corresponding to the random access resource;
beam identity information corresponding to the random access resource; and
resource position information for transmitting beam recovery information.

7. The beam failure processing method according to claim 1, wherein the beam failure recovery request message comprises at least one of the following:
beam failure indication information;
identity information of a cell in which a beam failure occurs; and
information of a beam that recovers from a beam failure.

8. The beam failure processing method according to claim 12, wherein the information of the beam comprises at least one of beam identity information and beam measurement information.

9. A terminal, comprising:
a processor, configured to: receive, from a network device side, configuration information of a random access resource for transmitting a beam failure recovery request message; and
when a beam failure occurs in the SCell, determine, based on an indication of the configuration information, whether to send a beam failure recovery request message to the network device.

10. The terminal according to claim 9, wherein the configuration information comprises at least one of the following:
cell identity information corresponding to the random access resource;
bandwidth part BWP identity information corresponding to the random access resource;
beam identity information corresponding to the random access resource; and
resource position information for transmitting beam recovery information.

11. The terminal according to claim 9, wherein the beam failure recovery request message comprises at least one of the following:
beam failure indication information;
identity information of a cell in which a beam failure occurs; and
information of a beam that recovers from a beam failure.

12. The terminal according to claim 11, wherein the information of the beam comprises at least one of beam identity information and beam measurement information.

13. A beam failure processing method, applied to a network device side, comprising:
sending, to a terminal, configuration information of a random access resource for transmitting a beam failure recovery request message.

14. The beam failure processing method according to claim 13, wherein after the step of sending, to a terminal, configuration information of a random access resource for transmitting a beam failure recovery request message, the method further comprises:
receiving a beam failure recovery request that is sent by the terminal with respect to the SCell by using a target random access resource;
wherein after the step of receiving a beam failure recovery request that is sent by the terminal with respect to the SCell by using a target random access resource, the method further comprises:
determining, based on the beam failure recovery request, whether to feed back beam recovery indication information to the terminal.

15. The beam failure processing method according to claim 13, wherein after the step of sending, to a terminal, configuration information of a random access resource for transmitting a beam failure recovery request message, the method further comprises:
receiving beam failure information of the SCell from the terminal side:
wherein the beam failure information comprises at least one of the following:
beam failure indication information;
beam recovery failure indication information;
a cell identity of the SCell;
a cell measurement result of the SCell;
a beam measurement result of the SCell;
a cell measurement result of another measured serving cell;
a beam measurement result of the another measured serving cell;
a cell measurement result of another measured non-serving cell; and
a beam measurement result of the another measured non-serving cell.

16. The beam failure processing method according to claim 13, wherein the configuration information comprises at least one of the following:
cell identity information corresponding to the random access resource;
bandwidth part BWP identity information corresponding to the random access resource;
beam identity information corresponding to the random access resource; and
resource position information for transmitting beam recovery information.

17. The beam failure processing method according to claim 13, wherein the beam failure recovery request message comprises at least one of the following:
beam failure indication information;
identity information of a cell in which a beam failure occurs; and
information of a beam that recovers from a beam failure.

18. The beam failure processing method according to claim 13, wherein the information of the beam comprises at least one of beam identity information and beam measurement information.

19. A network device, comprising a processor, a memory, and a computer program stored in the memory and capable of running on the processor, wherein when the processor executes the computer program, steps of the beam failure processing method according to claim 13 is implemented.

20. A non-transitory computer-readable storage medium, wherein the computer-readable storage medium stores a computer program, and when the computer program is executed by a processor, steps of the beam failure processing method according to claim 1 is implemented.
